(19) United States
(12) Patent Application Publication
(10) Pub. No.: US 2015/0211669 A1
(43) Pub. Date: Jul. 30, 2015

(54) FIXING DEVICE FOR SPOKE SENSOR

(71) Applicant: Philippe Van HOUTTE, Taichung City (TW)

(72) Inventor: Philippe Van HOUTTE, Taichung City (TW)

(21) Appl. No.: 14/166,669

(22) Filed: Jan. 28, 2014

(51) Int. Cl. F16L 37/24

(52) U.S. Cl. CPC F16L 37/24

(57) ABSTRACT

A fixing device for spoke sensor includes a main body and a screw member. Therein, the main body is provided with a sensing end and a screw end, with a sensed member disposed on the sensing end and a screw hole axially disposed on the screw end, wherein one side of the main body is concavely provided with an opening which is connected with the screw hole. The screw member is provided with a thread rod screwing in the screw hole, wherein one end of the thread rod is inserted into the opening. Therefore, the spoke is received through the opening of the main body, and thus pressed and fixed by one end of the thread rod and the wall of the opening, whereby the present invention is easily installed and suitable for various kinds of spokes.

### BACKGROUND OF THE INVENTION

1. Field of the Invention

The present invention relates to crank sensors installed on a bicycle wheel spoke for detecting moving speed, revolution speed, and moving distance of bicycles, and more particularly, to a fixing device for spoke sensor which is easily installed and disassembled, and suitable for a variety of spokes.

2. Description of the Related Art

For detecting the moving speed, revolution speed, and moving distance, an ordinary bicycle is provided with a displayer and a detecting device on the bicycle frame, and also provided with a sensed member on the wheel for revolving in accordance with the wheel, whereby the detecting device identifies the times of the sensed member passing by and thus calculates the moving speed, revolution speed, and moving distance of the bicycle.

Referring to FIG. 1, a known sensor comprises a main body 1 and a nut 2, wherein the main body 1 is provided with an outer thread 3 for screwing in the nut 2. One end of the main body 1 which is provided with the outer thread 3 is axially and concavely provided with a notch 4. The notch 4 receives a spoke 5, and then the main body 1 screws in the nut 2, whereby the spoke 5 is enclosed and positioned in the notch 4.

However, ordinary spokes includes not only a common column-shaped spoke having a consistent diameter of 1.8 mm, but also a diameter-varying spoke having two ends with a larger diameter and a flat middle section with a smaller diameter for decreasing the weight thereof, and a flat streamline-shaped spoke for decreasing air resistance such as a common carbon-fiber spoke. Regarding the diameter-varying spoke with a smaller middle section, because the notch 4 is designed for adapting the spoke with a consistent diameter of 1.8 mm, the notch 4 is larger and kept from appropriately receiving the spoke. As a result, the spoke is easily slidingly displaced from the original position due to the centrifugal force during the revolution of the wheel. Furthermore, the flat streamline-shaped carbon-fiber spoke is usually larger than the main body 1, thus unable to be received in the notch 4.

Furthermore, the spoke is allowed to be placed in the notch only when the nut 2 of the known sensed member is completely detached from the main body 1. Due to the relatively small size, the main body 1 and the nut 2 are both possibly lost after being disassembled, thereby causing inconvenience.

### SUMMARY OF THE INVENTION

For improving aforementioned difficulties, the present invention discloses a fixing device for spoke sensor which is easily installed and disassembled, and suitable for a variety of spokes.

The present invention provides a fixing device for spoke sensor, comprising:
a main body, provided with a sensing end and a screw end, with a sensed member disposed on the sensing end and a screw hole axially disposed on the screw end, wherein one side of the main body is concavely provided with an opening which is connected with the screw hole; and
a screw member, provided with a thread rod screwing in the screw hole, wherein one end of the thread rod is inserted into the opening.

The primary objective of the present invention is that the opening is allowed to be inserted by a spoke from one lateral side of the main body, and the screw member is allowed to effectively press toward the surface of the spoke in the opening, whereby the sensed member is easily fixed on the spoke. As a result, the present invention is easily installed and disassembled and produces a sufficient fixing effect.

The secondary objective of the present invention is that the opening further comprises an arc section and a channel section on the inner side of the opening. At least a part of the end of the thread rod overlaps the arc section for positioning various kinds of spokes. For examples, a standard column-shaped spoke with a diameter of 1.8 mm is fixed by the screw member in the arc section, and a flat streamline-shaped carbon-fiber spoke is inserted from the channel section and further clamped and fixed by the screw member and the arc section. In addition, the screw member is allowed to be adjusted to have different distances of inserting for fixing different spokes, whereby both wide carbon-fiber spoke and flat diameter-varying spoke are allowed to be fittingly pressed and clamped on the surface of the spoke by the screw member. Therefore, the present invention is able to be fixed on various kinds of spokes.

The third objective of the present invention is that the screw member screws in the screw hole by use of the thread rod. When disassembling the fixing device, the user needs only to screw the screw member out from the screw hole to release the thread rod against the spoke. As a result, the screw is not needed to be detached from the main body when the present invention is being disassembled, thereby decreasing the possibility of the components being lost.

### BRIEF DESCRIPTION OF THE DRAWINGS

FIG. 1 is a schematic view illustrating the status of installation of a known spoke sensor.

FIG. 2 is a perspective view of the fixing device for spoke sensor in accordance with the present invention.

FIG. 3 is an exploded view of the fixing device for spoke sensor in accordance with the present invention.

FIG. 4 is a perspective schematic view illustrating the present invention fixed on a spoke.

FIG. 5 is a schematic view illustrating an embodiment of the present invention installed on a column-shaped spoke.

FIG. 6 is a schematic view illustrating another embodiment of the present invention installed on a diameter-varying spoke.

FIG. 7 is a schematic view illustrating still another embodiment of the present invention installed on a carbon-fiber spoke.

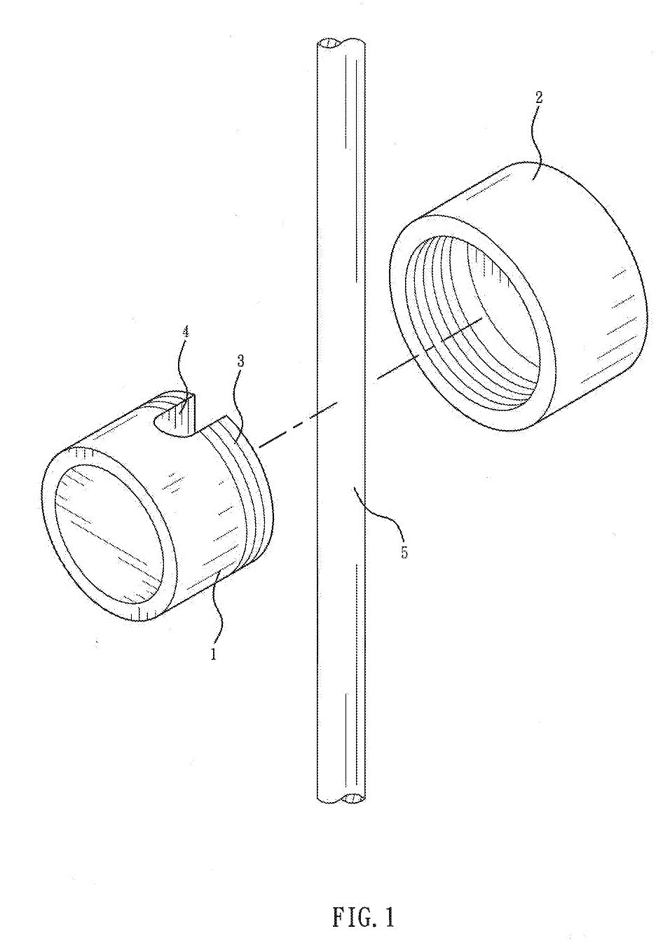

### DETAILED DESCRIPTION OF THE INVENTION

Other and further advantages and features of the present invention will be understood by reference to the description of the preferred embodiment in conjunction with the accompanying drawings where the components are illustrated based on a proportion for explanation but not subject to the actual component proportion.

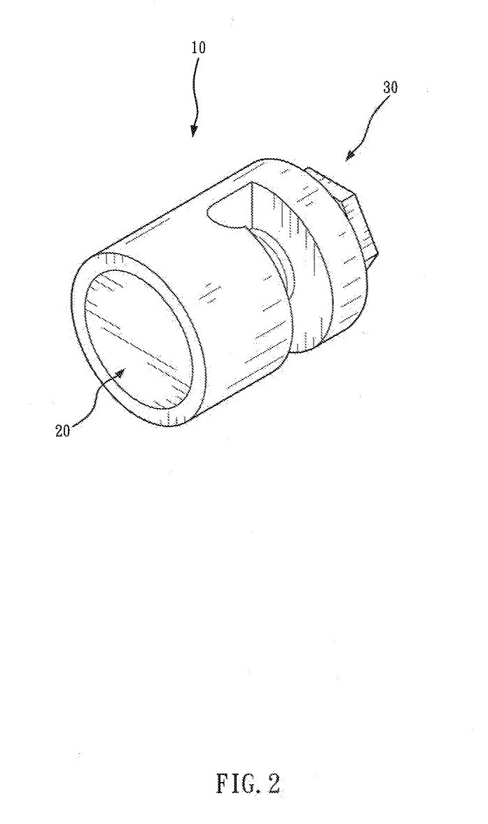

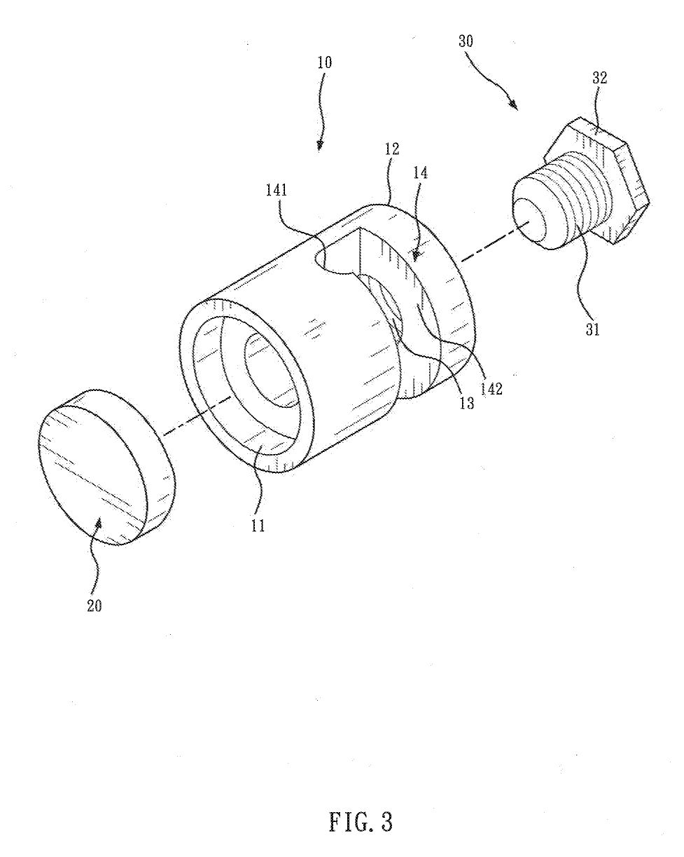

Referring to FIG. 2 and FIG. 3, the fixing device for spoke sensor provided by the present invention comprises:
a main body 10, provided with a sensing end 11 and a screw end 12, while a sensed member 20, which is a magnet, is disposed on the sensing end 11, and a screw hole 13 is axially disposed on the screw end 12, wherein one lateral side of the main body 10 is provided with an opening 14 concavely and radially along the main body 10, and the opening 14 is connected with the screw hole 13; the measure of area on a cross-section of the main body 10 provided with the opening 14 accounts for at least half of the cross-section of the main body; furthermore, the opening 14 comprises an arc section 141 on the inner side thereof and a channel section 142; and
a screw member 30, provided with a thread rod 31 screwing in the screw hole 13, wherein one end of the thread rod 31 is inserted into the opening 14, whereby at least a part of the end of the thread rod 31 is able to overlap and push toward the arc section 141; also, an end of the screw member 30 opposite against the thread rod 31 is provided with a tool end 32 present as a polygonal face, wherein the tool end 32 is a hexagonal face in a preferred embodiment, thereby facilitating the rotation driven by hands or tools such as a wrench.

The structural detail of the present invention is introduced, and the method of operation of the present invention is described below.

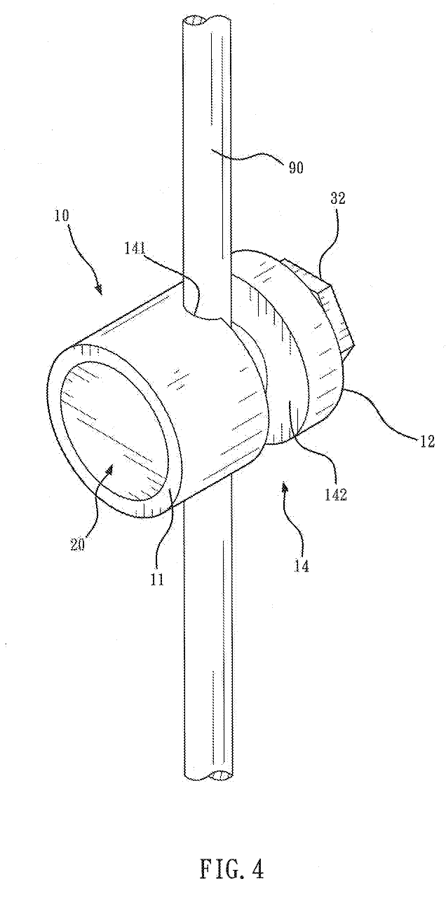

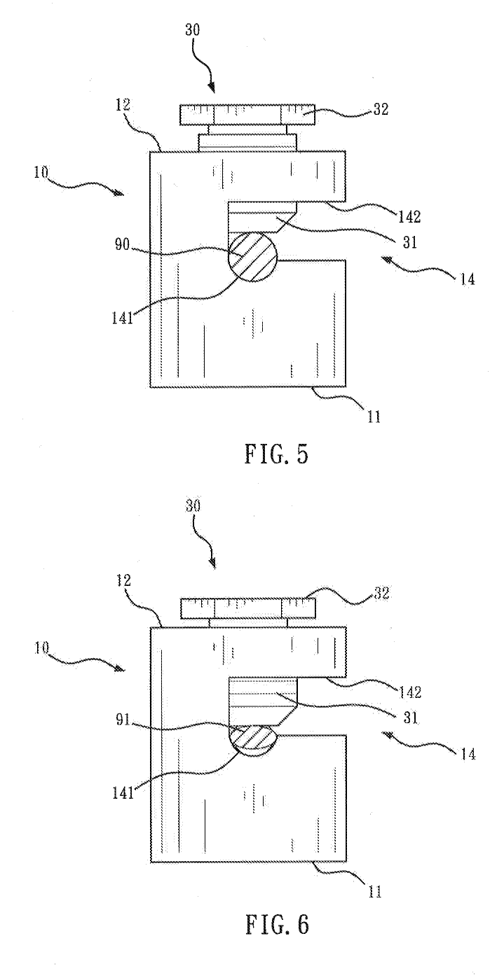

Referring to FIG. 4 and FIG. 5, when the present invention is to be fixed on a spoke 90, first, the screw member 30 is rotated outward to be loosened, whereby the distance between the distal end of the thread rod 31 and the wall of the opening is equal to or larger than the width of the spoke 90. Next, the spoke 90 is inserted from a later side of the main body 10 in the opening 14. Regarding the column-shaped spoke 90 as shown in FIG. 4 and FIG. 5, due to the shape and size of the arc section 141 designed in accordance with a standard 1.8 mm column-shaped spoke, the spoke 90 is allowed to be received in the arc section 141. Third, the tool end 32 of the screw member 30 is rotated for fastening shortening the distance between the end of the thread rod 31 and the wall of the opening 14, whereby the spoke 90 is pressed and positioned between the arc section 141 of the opening 14 and the end of the thread rod 31. Thus, the process of fixing the present invention is completed. Furthermore, the arc section 141 is designed to improve the fixing effect upon the spoke 90, thereby preventing the spoke 90 from detaching from the main body 10.

On the other hand, when the present invention is to be disassembled, the user needs only to reversely rotate the tool end 32 to make the distance between the end of the thread rod 31 and the wall of the opening 14 equal to or larger than the width of the spoke 90, whereby the spoke 90 is allowed to be removed from the opening 14. As a result, when disassembling the present invention, the thread rod 31 is only needed to be partially screwed out of the screw hole 13 for being loosened against the spoke 90; in other words, the screw member 30 is not needed to be wholly detached from the main body 10, thereby reducing the risk of losing components.

In addition, referring to FIG. 6, when the present invention is applied on a diameter-varying spoke 91, the screw member 30 is used to adjust the distance between the end of the thread rod 31 and the wall of the opening 14. Therefore, even a flat-shaped diameter-varying spoke 91 is able to be pressed and fixed in the opening 14 by the screw member 30, whereby the accidental sliding due to the centrifugal force of wheel during the revolution of the wheel is prevented.

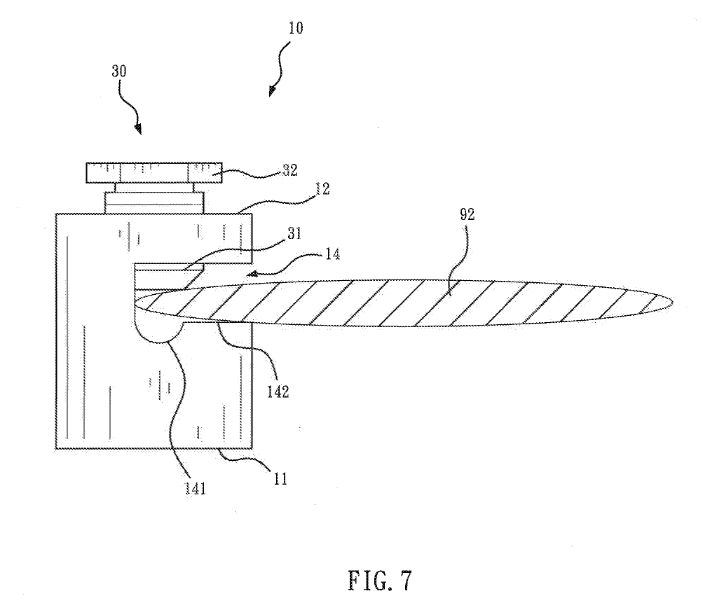

Referring to FIG. 7, when the present invention is applied on a carbon-fiber spoke 92, which usually possesses a whole size larger than the size of the main body 10, a lateral side of the spoke 92 is partially inserted from the channel section 142 to contact the arc section 141 with the screw member 30 rotated and fastened afterward, whereby the end of the thread rod 31 presses the surface of the lateral side of the carbon-fiber spoke 92, thus finishing the installation of the present invention on the carbon-fiber spoke 92.

The present invention is not only easily installed and disassembled, but also suitable for various kinds of spokes, including an ordinary column-shaped spoke 90, a diameter-varying spoke 91, and a carbon-fiber spoke 92.

With the explanation above, skilled people in the field of the present invention are allowed to understand the technical difference between the present invention and prior arts. Also, it is clear that the present invention achieves functions unachievable by prior arts. Therefore, the patentability of the present invention is assured.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A fixing device for spoke sensor, comprising:
a main body, provided with a sensing end and a screw end, with a sensed member disposed on the sensing end and a screw hole axially disposed on the screw end, wherein one side of the main body is concavely provided with an opening which is connected with the screw hole; and
a screw member, provided with a thread rod screwing in the screw hole, wherein one end of the thread rod is inserted into the opening.

2. The fixing device for spoke sensor of claim 1, wherein the opening comprises an arc section and a channel section.

3. The fixing device for spoke sensor of claim 2, wherein the arc section is disposed on the inner side of the opening.

4. The fixing device for spoke sensor of claim 3, wherein at least a part of one end of the thread rod is able to overlap and push toward the arc section

5. The fixing device for spoke sensor of claim 3, wherein the measure of area on a cross-section of the main body provided with the opening accounts for at least half of the cross-section of the main body.

6. The fixing device for spoke sensor of claim 1, wherein the sensed member is a magnet.

7. The fixing device for spoke sensor of claim 1, wherein the screw member is provided with a tool end which is present as a polygonal face.

8. The fixing device for spoke sensor of claim 7, wherein the tool end is present as a hexagonal face.
